(19) United States
(12) Patent Application Publication
(10) Pub. No.: US 2013/0266768 A1
(43) Pub. Date: Oct. 10, 2013

(54) METHOD FOR PRODUCING A PART CONTAINING AN EMBEDDED PATTERN AND RESULTING PART

(71) Applicants: Fabienne Dragin, Grenoble (FR); Chrystel Deguest, Grenoble (FR)

(72) Inventors: Fabienne Dragin, Grenoble (FR); Chrystel Deguest, Grenoble (FR)

(21) Appl. No.: 13/884,011

(22) PCT Filed: Oct. 27, 2011
(86) PCT No.: PCT/EP11/68819

§ 371 Date: Jun. 7, 2013

(30) Foreign Application Priority Data
Nov. 8, 2010 (FR) 1059214

(51) Int. Cl. B44C 1/22; B44F 1/06

(52) U.S. Cl. CPC B44C 1/227; B44F 1/06
USPC 428/166; 156/257

(57) ABSTRACT

A process for producing a part containing an embedded pattern includes preparing a first and a second substrate, at least one of which is transparent, wherein preparing the first substrate includes forming at least one trench in a surface thereof, the surface being a surface intended to be bonded to the second substrate; joining the first substrate and the second substrate by molecular bonding, the trench bounding a hollow volume that defines the embedded pattern, the hollow volume communicating with an exterior of the joined first and second substrates; and causing a fluid dye to flow in the hollow volume in order to dye at least certain walls.

### TECHNICAL FIELD

The invention relates to a process for manufacturing complex parts comprising dyed embedded etched structures with micron-sized dimensions (i.e. microscale structures) and produced by joining elementary substrates by molecular bonding.

The invention therefore especially allows a part containing an embedded pattern to be manufactured, the dimensions of which are at most micron-sized.

The expression “dimensions are at most micron-sized” is understood to signify an embedded pattern the largest dimension of which is typically smaller than 1 mm, and preferably smaller than 500 μm or 250 μm.

The invention has applications in various industrial, cultural or artistic fields. It may thus be applied in the watch and clock making industry to produce very high-quality graphics or semitransparent decorations in watch glasses or on watch casings. In the field of jewelry, it may be used to produce gems comprising micron-sized or even nanoscale decorations or texts.

### PRIOR ART

In the aforementioned fields of jewelry and gem cutting or watch and clock making, the use of micromechanical and micro-connection techniques and of electronic components is widespread. Microtechnology is thus in particular used to produce elementary components, for example a spiral spring made of silicon (especially used by Ulysse Nardin®).

In contrast, there are no known applications for complex parts made from permanently joined, optionally micro-machined, crystals or other substrates comprising microscopic etchings. A fortiori, there are no known applications for producing complex parts comprising micron-sized or even nanoscale dyed etchings within complex structures.

The production of microscopic etchings, for decorative purposes, graphics or texts is known. Several companies such as Graphilux International, Norsam or Lightsmith provide etchings produced on the surface of generally rather weak substrates; however, these etchings would not appear to be very durable and mechanically robust. By way of example, in document FR 2 851 496 of Jean-Louis Savoyet et al., it is proposed to securely fasten the object and its graphic by bonding, crimping or inclusion. These techniques have several limitations. Adhesives are organic materials possibly, on the one hand, having a limited lifetime, and on the other hand, optical properties that change over time and degrade the readability of the graphics. Crimping produces a solid mechanical assembly but does not provide enough robustness from the point of view of the integrity of the object and its graphic to, for example, ensure inviolable traceability. This is because crimping can be undone without destroying the object.

Moreover, technologies are known for producing extremely robust micron-sized images with excellent definition, which allow the aforementioned limitations to be avoided. In this respect, the following two documents may be cited.

Document FR 2 926 747 (CEA—invention of A. Rey and C. Deguet) relates to an object comprising a graphical element added to a medium and to a process for producing such an object; such an object is equipped with at least one graphical element comprising at least one layer etched with a graphical pattern element, a first side of said layer being placed facing one side of at least one partially transparent substrate, a second side of said layer, opposite the first side, being covered with at least one passivation layer securely fastened to at least one side of at least one medium by molecular bonding, and forming, with the medium, a monolithic structure. In practice, the etched layer is formed, before etching, by deposition on the substrate; after the etching has been carried out, this etched layer is coated with the passivation layer, which is also deposited.

Document FR 2 926 748 (CEA—invention by A. Rey, J. F. Clerc, A. Soubie) relates to an object equipped with a graphical element added to a medium and to the process for producing such an object. This object is equipped with at least one graphical element comprising at least one at least partially transparent substrate at least one side of which comprises hollows forming a graphical pattern element filled with at least one material, said side of the substrate being securely fastened to at least one side of at least one medium by molecular adhesion, the substrate and the medium forming a monolithic structure

It will be noted that, in these documents, the color of the graphical elements is set either by the material of the etched layer or by the filling material, which in practice leads to a choice that is limited to shades of grey, or yellow in the case of gold.

Moreover, there are many techniques for printing color images onto flexible or rigid media. However, at the present time known techniques do not allow very small permanent color images to be produced using micron-sized or even nanoscale pixels. Furthermore, these techniques do not allow images to be produced that resist mechanical attack (scratches), chemical attack, biological attack (mold), and thermal attack (fire).

In a different technical field, it is known to produce CMOS or CCD image sensors that use small colored pixels, however the latter are not intended to hold permanent images.

### SUMMARY OF THE INVENTION

The object of the invention is to overcome the aforementioned drawbacks by providing a process for producing parts comprising embedded micron-sized or even nanoscale etchings, which can be dyed with a wide range of colors and shades, within structures that are joined as durably as possible.

The invention provides for this purpose a process for producing a part containing an embedded pattern the dimensions of which are at most micron-sized, in which:
first and second substrates are prepared at least one of which is transparent, at least one trench being formed in at least one of these substrates in a surface intended to be bonded to the other substrate;
the first and second substrates are joined by molecular bonding, said at least one trench bounding a hollow volume the configuration of which defines the embedded pattern, this hollow volume communicating with the exterior of the joined first and second substrates; and then
a fluid dye is made to flow, at least temporarily, in this hollow in order to dye at least certain walls.

Preferably, the process of the invention is applied to the production of complex transparent parts, advantageously formed from transparent crystals, which may be natural or synthetic crystals.

It will be understood that the process of the invention has many advantages, among which the following may be mentioned:

it allows complex parts to be produced from a large monolithic (for example crystal) substrate, which is difficult if not impossible to achieve with mechanical machining;

it also allows several types of substrate chosen for their physical (color etc.), chemical or mechanical properties to be joined; and

it provides the parts produced with unrivalled robustness, reliability, and durability.

According to advantageous features, which can optionally be combined:
the hollow volume communicates with the exterior along the molecular bonding interface (which is simple to achieve but involves long communication paths); as a variant, the hollow volume communicates with the exterior via channels placed transversely to the molecular bonding interface (the communication paths can then be shorter, but this involves producing a via in one of the substrates);
trenches are formed in each of the first and second substrates, these trenches communicating with one another and bounding said hollow volume (this makes a wide variety of patterns possible);
the trenches are formed at the same time as internal pads, forming spacers, these internal pads extending from the bottom of a trench in one of the substrates to make contact with the other substrate;
continuous internal partitions are formed bounding at least two chambers in the hollow volume, each of the chambers communicating with the exterior, different fluid dyes being injected into each of these chambers (as a variant, the chambers are separated by continuous partitions); these partitions may be formed by contiguous pads;
the fluid dye contains a colored substance, for example metal or organic particles the average diameter of which is about one-hundred nanometers at most (this average diameter may be chosen depending on the dimensions of the trenches);
each of the first and second substrates is transparent; preferably both substrates are made of the same material (in this case the molecular bonding interface is substantially invisible);
the trenches are formed by etching through by lithography masks;
a treatment suitable for increasing roughness is applied to at least certain of the walls of the hollow volume; and
some of the fluid dye injected remains permanently in the hollow volume; this may strengthen the color and/or allow possibly variable color effects to be obtained.

It will be understood that it is advantageous, after the fluid dye has been injected, to block the communication passages between the hollow volume and exterior, especially if fluid dye remains in the hollow volume.

The invention also relates to a part obtained by such a process, i.e. a part containing an embedded pattern the dimensions of which are at most micron-sized, comprising first and second substrates at least one of which is transparent, and which are bonded to each other by molecular bonding, at least one hollow volume being formed in one and/or other of the substrates in immediate proximity to the bonding interface and opening onto the exterior, at least certain of the walls of this hollow volume being covered with a dying component; this dying component may consist of dying particles; this component may, as a variant, form part (or even consist of) a colored liquid at least partially filling this hollow volume.

The part (which may be a piece of jewelry or a timepiece) thus defined preferably has advantageous features resulting from those mentioned with regards to the process; among which, in particular, the following may be mentioned:
both substrates are transparent;
both substrates are made of the same material (the part thus produced appears to be a monolithic part, because the interface is then substantially invisible);
the hollow volume comprises pads extending over the entire height of this hollow volume; and
the hollow volume comprises a plurality of chambers at least certain of the walls of which are covered with dying components of different colors, respectively. These dying components may be dying particles or colored liquids, these dying particles and/or these liquids having colors that differ from one chamber to another (one chamber may contain a dying liquid while the other contains dying particles).

These parts may find applications in many fields:

luxury goods, in complex parts for timepieces or uncrimped gem assemblies for jewelry;

but also in decorations; and

even in ultra long-term data storage.

It will be noted that known processes do not involve forming trenches that are not filled with a solid material, having surface finishes controlled in order to provide optical or physical functions.

### DESCRIPTION OF THE INVENTION

Objects, features and advantages of the invention will become clear from the following description, which is given by way of nonlimiting illustration and with regard to the appended drawings in which:

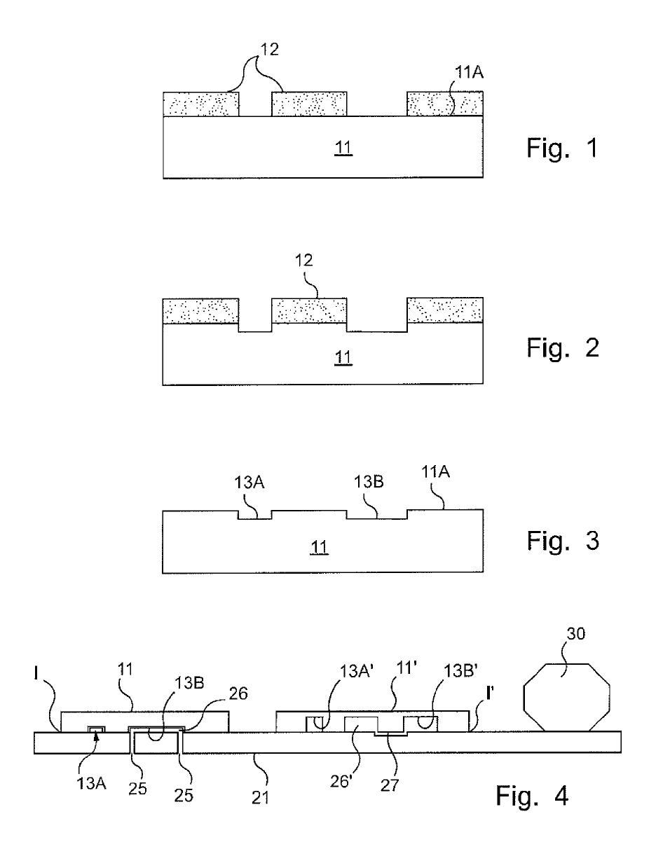

FIG. 1 is a cross-sectional view of a crystalline substrate covered with a lithography mask;

FIG. 2 is another view after etching through the mask;

FIG. 3 is another view after the lithography mask has been removed;

FIG. 4 is a cross-sectional view of a second substrate to which the first substrate from FIGS. 1 and 2 has been fixed by molecular bonding after flipping, and to which another exemplary first substrate has been fixed;

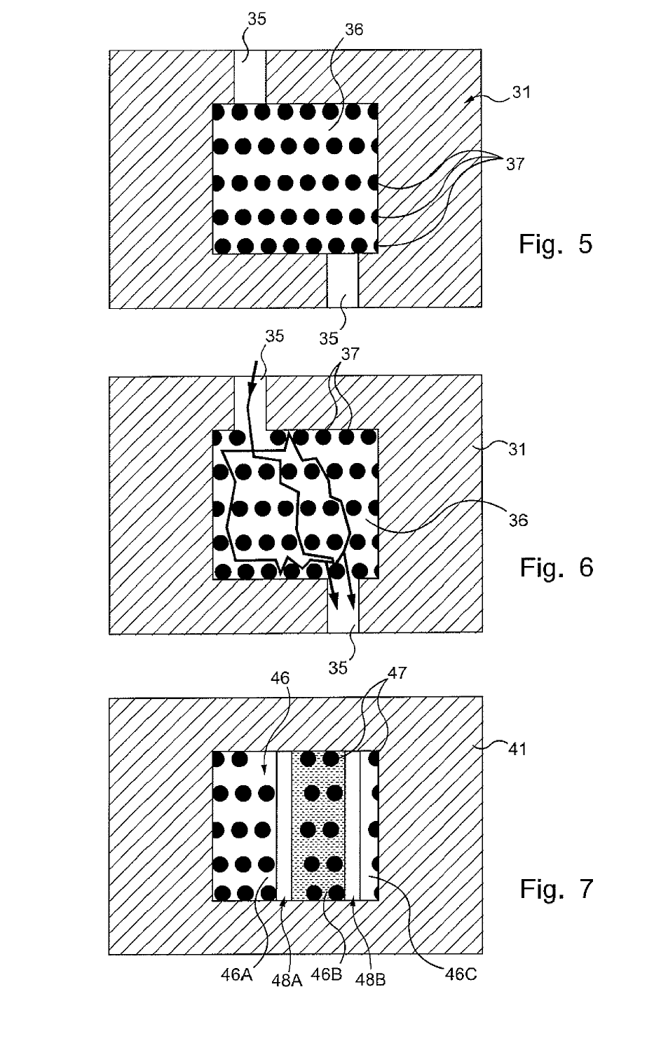

FIG. 5 is a schematic showing, from above, the hollow volume that exists in another exemplary assembly;

FIG. 6 is another schematic during injection of a fluid dye; and

FIG. 7 is another schematic of another exemplary assembly the volume of which comprises three zones that are substantially isolated from one another.

### PROCESS FOR MANUFACTURING MICROSCOPIC ETCHINGS

The figures schematically show the process of the invention, in which:
first and second substrates are prepared at least one of which is transparent, at least one trench being formed in at least one of these substrates in a surface intended to be bonded to the other substrate; this trench opens onto the exterior, on the edge of this substrate or on that face of this substrate which is opposite the bonding face;
the first and second substrates are joined by molecular bonding (or direct bonding), said at least one trench bounding a hollow volume the configuration of which defines the embedded pattern, this hollow volume communicating with the exterior of the joined first and second substrates (via the aforementioned through-passages); and then
a fluid dye is made to flow, at least temporarily, in this hollow in order to dye at least certain walls.

Thus, FIG. 1 shows a first substrate, referenced 11, in which at least one trench will be defined by etching.

This first substrate 11 is advantageously transparent and is either amorphous (glass etc.) or crystalline (sapphire, quartz, diamond etc.). It is advantageously a crystal.

First (see FIG. 1) a surface 11A of this substrate is covered with an etching mask 12; this mask may be a mineral mask (metal, oxide such as silica, etc.) or an organic mask (photoresist etc.).

Next (see FIG. 2), the first substrate is etched under the surface 11A, through the mask 12. This may be an isotropic or anisotropic chemical etch or a dry etch (plasma method, reactive ion etching, or ion milling, especially). FIG. 2 shows two trenches 13A and 13B obtained in this way. These trenches are typically chosen to be about a few tens of nanometers to a few hundred microns in depth, their depths optionally being different.

Next (see FIG. 3), the mask is removed by any known suitable means without degrading the surface 11A (as a variant, the subsequent surface preparation treatment may be used to remove any degradation).

The trenches may be structured as required:
profile of the edges of the etch: vertical or inclined sidewalls;
etching bottom: smooth bottom or bottom that is “unpolished” by virtue of the roughness obtained by the etching process;
depth: changed as required or even localized through-etching.

In the example considered here, the other of the substrates, referenced 21 in FIG. 4, is also equipped with trenches. This other substrate is here also advantageously transparent, amorphous or crystalline (see the above remarks regarding the first substrate), and preferably also consists of a crystal. Preferably, the two substrates 11 and 21 are made of the same material, so that they have identical transparencies.

The melting point of the substrates 11 and 21 is above 25° C., and preferably above 200° C., 400° C. or 1000° C.

The configuration of the trenches formed in one and/or other of the substrates is chosen so that, conjointly, these trenches bound, after the subsequent bonding step, a hollow volume the configuration of which defines the embedded pattern to be produced.

After the etching mask has been removed, a surface treatment may be carried out (deposition of a layer providing a chemical functionalization, PVD or CVD deposition etc.), this surface treatment may also be selectively removed, for example by chemical-mechanical polishing of the top parts of the trenches, in order to remove traces of the etching step.

These micro-etched crystals may then be mechanically machined into the desired shapes (for example into a heart shape for a piece of jewelry)

The trenches defined in one and/or other of the substrates are such that the hollow volume communicates with the exterior (this will become clearer below), at least after the optional machining step used to define the outline of the future bonded assembly.

### Joining of the Crystals

The various substrates or crystals, whether natural or synthetic, with microscopic etchings or unetched, are joined together by direct bonding, a.k.a molecular bonding, without an intermediate adhesive layer.

To do this, the substrates advantageously receive a specific surface treatment, known per se (modification of the roughness, planarity, cleaning, surface preparation (wet and/or dry activation); they are then brought into contact, with a precise alignment if necessary, especially if complementary trenches have been formed in each of the substrates. The direct bonding is strengthened by a heat treatment, for example at a temperature between 200 and 950° C. depending on the robustness desired and the materials used. The temperature of this heat treatment however remains below the melting point of the substrates 11, 21.

In FIG. 4, the substrate 11 of FIGS. 1 to 3 (see the left-hand part of this figure) has lateral dimensions that are much smaller than those of the second substrate 21. Specifically, FIG. 4 shows, in its right-hand part, another example of complementarity between another first substrate, referenced 11′, and this second substrate 21.

In the left-hand part of FIG. 4, the second substrate has been etched only in order to form channels 25 extending from the bonding surface, transversely to said surface (here perpendicularly to it), to the opposite face, by virtue of which channels the hollow volume 26 bounded by the trenches formed in the first substrate communicates with the exterior.

It should be understood here that this communication with the exterior may also be achieved by way of another (or a plurality of other) hollow volume(s).

In the right-hand part, the second substrate comprises a trench 27 placed facing one (13B′) of the trenches 13A′ and 13B′, so as to form, conjointly, a hollow volume 26′ partially located in the first substrate 11′ and partially in the second substrate 21 (in the example considered, this trench 27 faces a portion protruding from this substrate, thereby placing left- and right-hand portions of the trench 13B′ in communication). Providing trenches in each of the substrates makes it possible to produce complex configurations. The difference in the depth of the trenches 13 A′ and 13 B′, on the one hand, and the trench 27, on the other hand, may allow, during the subsequent dying step, slightly different shades to be obtained using the same fluid dye. Trenches (not shown) form channels of communication with the exterior (not shown), these trenches being located along the bonding face.

The bonding interface of the left-hand part is referenced I and that of the right-hand part is referenced I′.

One or more cut crystals (see the octagon 30 in FIG. 4) may be bonded, using an adhesive substance or by molecular bonding, to the surface of one of the substrates in order to produce macroscopic designs, for example for decorative purposes. Specifically, a plurality of substrates may have their entire surface bonded to an identical substrate that is furthermore equipped with decorative patterns; as a variant, two substrates may be provided each of which overlaps with the other, one and/or other of these substrates furthermore bearing one or more decorative patterns.

With reference to FIGS. 5 to 7, the hollow volume may comprise a plurality of pads and/or partitions extending from its bottom in one of the substrates to the other of the substrates; specifically, the hollow volume may have, parallel to the molecular bonding interface, dimensions that are much larger than the depth of these volumes: the presence of such pads allows, in the way of spacers, the distance between the bottom of a given hollow volume, in one substrate, and the surface of the other substrate to be kept constant, thereby possibly contributing to uniform dying in the hollow volume in question; furthermore, these pads contribute to the molecular bonding.

It will be understood that the interface between the substrates is all the harder to see the more the constituent materials of the two substrates have compositions and properties that are similar; this interface is substantially invisible in the case of substrates made from identical materials.

### Dying of the Joined Crystals.

According to the invention, a step of dying the substrates is carried out after they are joined. The dying is obtained by injecting a colored fluid substance into at least some of the hollow volumes defined by the trenches, at the bonding interface. The colored fluid substance infiltrates by capillary action and thus allows the hollow volume in question to be dyed. For this purpose, infiltration pathways, existing between the etched parts and the bonded parts of the crystals, are used; with reference, by way of example, to the left-hand part of FIG. 4, such an infiltration pathway is formed by one of the channels 25 in FIG. 4, the other channel allowing the gas trapped during bonding, and forced out by the penetration of said fluid, to escape.

The colored fluid substance may take the form of a liquid or gas. Multicolor dying may be obtained by defining different single-color infiltration pathways. Likewise, it is possible to promote variations in shade by mixing colors. It may be a fluid, for example a solvent, filled with dying particles that are advantageously deposited on the walls of the hollow volume.

It will be understood that the dynamic of the capillary infiltration depends on the dimensions of the infiltration pathways and of the hollow volumes, on the distance to be traveled by infiltration, and on the viscosity of the fluid substance; in the case of multiple hollow volumes there is a compromise to be found between the number of infiltration pathways and the number of hollow volumes connected in series (if all the hollow volumes are connected in series, the infiltration dynamic will be slow; if specific infiltration pathways are provided for each hollow volume, the dynamic will be more rapid but at the cost of the routing of the infiltration pathways possibly being complex). If required, this infiltration may be carried out at a temperature above room temperature in order to reduce viscosity.

Specifically, when the fluid dye is a gas, it would be expected that it would flow easily in the hollow volume. In contrast, when it is a liquid, it may be difficult to make it flow in the hollow volume. One way of promoting the injection and flow of the fluid, especially when it is a liquid, is to apply a heat treatment that acts to reduce the viscosity of the fluid, but also, if required, promotes evaporation of the constituent solvent of the fluid when it is a liquid.

When it is desired to trap the fluid dye in the hollow volume, the communication orifices are advantageously blocked after a sufficient amount of fluid has been injected (see below).

FIG. 5 schematically shows an assembly 31 of an etched transparent substrate and an unetched transparent substrate, the pattern formed by the trenches is embedded in this assembly at the bonding interface. For the sake of legibility, the molecularly bonded part of this assembly, which is free of trenches, has been hashed, whereas the much lighter region represents a hollow volume 36 (the substrates as such cannot be seen because they are transparent). As explained above, pads 37 are distributed inside this hollow volume (and near its periphery). Inlet/outlet pathways 35 (corresponding to the infiltration pathways of FIG. 4) are here placed in the plane of the interface (or at least in immediate proximity to said interface).

During the dying step (see FIG. 6), the fluid dye is brought into communication with one of the infiltration pathways 35, here the pathway located in the top part of FIG. 6. The configuration of the pads is such that flow pathways remain between the inlet/outlet pathways 35; these flow pathways may spread out and then regroup near the output pathway. The fluid infiltrates, by capillary action, from the input pathway to the output pathway, between the pads; advantageously, the configuration in FIG. 6 corresponds to the spatial configuration of the assembly 31, i.e. the face through which the fluid dye penetrates (the top one in the plane of the figure) is located above the face through which this fluid leaves the assembly (the bottom one in the plane of the figure); in other words, gravitational capillary action may be what causes the fluid to flow. The uniformity of the dying of the hollow volume will be increased if the fluid can reach everywhere in the hollow volume.

The dying results, either from the deposition of dying particles on the walls of the hollow volume, especially the walls (or sides) parallel to the bonding interface, but also its sidewalls, or from the presence of the colored fluid itself in the hollow volume. It will be understood, in the case of particle deposition, that the effect of trapping of the dying particles on these walls depends on their surface finish, and that it may be advantageous for the surfaces of these walls not to be too smooth. It will also be understood, when the dying mainly results from the presence of fluid trapped in the hollow volume, that the flow of this fluid may be extremely limited (for example just enough to allow total or partial filling of the hollow volume). Of course, both a substantial flow of fluid and the presence of a trapped fluid may lead to dying particles being deposited on the walls (sidewalls or otherwise).

FIG. 7 illustrates a variant showing an assembly 41 in which the hollow volume 46, equipped with pads 47, is divided into three independent chambers referenced 46A, 46B and 46C. Here, the chambers are separated by continuous walls 48A and 48B; these walls are here shown in white and are independent from the rest of the substrates (specifically they may be regions added after etching, such as pads; as a variant, these partitions and/or these pads may be regions that were not etched during the etching of the trenches forming the hollow volume). The partitions may be formed by contiguous pads. The inlet/outlet infiltration pathways are not shown, since they lie perpendicular to the plane of the figure; specific pathways are provided for each of the chambers. By injecting fluid dyes of different colors, three regions of different colors are obtained.

It will be understood that the shorter the inlet/outlet pathways are, the smaller the risk that regions other than those desired will be dyed; however, this risk may be minimized by making the walls of these pathways very smooth.

In particular, solutions colored with nano particles in solution may in particular be used. These nano particles may be very small sized metal particles, for example gold (Au) particles about a few nanometers in size and possibly ranging up to about 100 nm in size. These particles may be protected by a carapace that provides them with a good thermal resistance, for example a zirconia (ZrO₂) carapace around gold particles. This carapace modifies the optical properties of the particle, and this must be taken into account when considering how to implement the process. The choice of materials and size of the nanoparticles will be made depending on the color properties desired.

By modifying the size and density of the particles (for example the gold particles described above), different colors (yellow, red, green, etc.) and shades of color can be obtained, via diffraction effects, as required.

Other dying particles may be used. Thus, the particles may especially be mineral particles, and, for example, comprise an oxide such as iron oxide, chromium oxide, manganese oxide, or aluminum oxide, or mixtures of such oxides, or comprise a metal or an alloy such as spinel, chromium or cobalt.

The particles may also be organic particles, phthalocyanine particles for example.

The particles may also be Au, Ag or Pt plasmonic particles or even using particles made of organic molecules in a mineral matrix.

As a variant, the particles may be coated with refractory materials such as alumina, zirconia, or zircon.

The particles may be suspended in a solvent; when the dying is intended to be achieved by trapping the fluid in the hollow volume, the color is advantageously stable throughout the volume of this fluid.

The assemblies obtained in this way after this dying step may be a wide range of sizes, even if the relative proportions between the outline of this assembly and the dimensions of the hollow volume are in fact very different from those shown in figures.

These assemblies, which make up the parts that it is desired to produce, may be subjected, especially if it is desired to keep the injected colored fluid therein, to a coating operation for hermetically sealing (for example using resins or a polymer or an adhesive or even by local melting of the material (the expression “exhaust sealing” sometimes being used when the sealing takes place after gas contained in the hollow volume has been evacuated)) the interior of the hollow volumes by plugging the inlet/outlet infiltration pathways.

### Particular Advantages Obtained by the Invention

Thus, it will be appreciated that the present invention makes it possible to produce:
complex parts made from a number of crystals
joined together by molecular bonding,
containing embedded patterns, channels or fluid networks;
said patterns, channels or fluid networks possibly being sealed or open ended in order to allow them to be filled with the colored substance;
said patterns, channels or fluid networks possibly being coated or having surface treatments providing a number of fundamental advantages;
the use of a number of colored substances allowing one or more colors to be obtained in the hollow volumes defined beforehand.

### INDUSTRIAL APPLICATIONS OF THE INVENTION

The invention may be applied in various industrial, cultural or artistic fields.

In the watch and clock making industry, complex watch parts (for example casings or mechanical subassemblies) can be produced by joining, by molecular bonding, machined or micro-machined crystals. This may especially be applied to what are called “skeleton” watches.

In the field of jewelry, gems, with or without decorations or text produced by etching on the microscale (even nanoscale), may be joined, without adhesive bonding or crimping, to metals. These parts may have complex shapes, and particularly allow the transparency or maximum optical effects of the component crystals to be emphasized by virtue of the absence of opaque metal parts.

However, various variants may be envisioned regarding the particular embodiments defined above. Thus, in particular, only one of the substrates may be transparent. The trenches may be obtained by depositing material around regions intended to form the hollow volumes. The chambers may be separated by continuous partitions.

1-15. (canceled)

16. A process for producing a part containing an embedded pattern, said process comprising preparing a first and a second substrate, at least one of which is transparent, wherein preparing said first substrate comprises forming at least one trench in a surface of said first substrate, said surface being a surface intended to be bonded to said second substrate, joining said first substrate and said second substrate by molecular bonding, said trench bounding a hollow volume that defines said embedded pattern, said hollow volume communicating with an exterior of said joined first and second substrates, and causing a fluid dye to flow in said hollow volume in order to dye at least certain walls.

17. The process of claim 16, wherein said hollow volume is in communication with said exterior along a molecular bonding interface.

18. The process of claim 16, wherein said hollow volume is in communication with said exterior via channels placed transversely to a molecular bonding interface.

19. The process of claim 16, wherein forming at least one trench comprises forming trenches in each of said first and second substrates, said trenches communicating with one another and bounding said hollow volume.

20. The process of claim 16, wherein forming at least one trench comprises forming trenches concurrently as internal pads, said internal pads extending from a bottom of a trench in said first substrate to make contact with said second substrate.

21. The process of claim 16, further comprising forming continuous partitions bounding at least two chambers in said hollow volume, each of said chambers being in communication with said exterior, and injecting different fluid dyes into each of said chambers.

22. The process of claim 16, wherein causing a fluid dye to flow comprises causing flow of a fluid dye comprising metal particles having an average diameter of at most one-hundred nanometers.

23. The process of claim 16, wherein causing a fluid dye to flow comprises causing flow of a fluid dye comprising organic particles having an average diameter of at most one-hundred nanometers.

24. The process of claim 16, further comprising applying, to at least certain walls of said hollow volume, a treatment suitable for increasing roughness.

25. The process of claim 16, wherein said fluid dye remains permanently in said hollow volume.

26. The process of claim 16, wherein said fluid dye remains temporarily in said hollow volume.

27. The process of claim 16, further comprising selecting said embedded pattern to be at most micron-sized.

28. A manufacture comprising a part containing an embedded pattern, said part comprising first and second substrates bonded to each other by molecular bonding at a bonding interface, at least one of said first and second substrates being transparent, and at least one hollow volume in said first substrate in immediate proximity to said bonding interface and opening onto an exterior of said joined first and second substrates, said hollow volume comprising certain walls that are covered with a dyeing component.

29. The manufacture of claim 28, wherein said first substrate is transparent and said second substrate is transparent.

30. The manufacture of claim 28, wherein said hollow volume comprises pads extending over an entire height of said hollow volume.

31. The manufacture of claim 28, wherein said hollow volume comprises a plurality of chambers, said chambers comprising walls coated with dyeing components of different colors.

32. The manufacture of claim 28, wherein a fluid comprising said dyeing component is trapped in said hollow volume.

33. The manufacture of claim 28, wherein said dimensions of said embedded pattern are at most micron-sized.
